(19) United States
(12) Patent Application Publication
(10) Pub. No.: US 2025/0173133 A1
(43) Pub. Date: May 29, 2025

(54) SYSTEMS AND METHODS FOR IMPROVING COMPUTING PERFORMANCE BY IMPLEMENTING AN APPLICATION PACKAGE ORCHESTRATOR IN AN ELECTRONIC ENVIRONMENT

(71) Applicant: BANK OF AMERICA CORPORATION, Charlotte, NC (US)

(72) Inventors: Eena Jain, Gurugram (IN); Samir Chandrakant Shinde, Mumbai (IN); Anand Govuri, Hyderabad (IN); Riaz Mohammad Shaik, Fremont, CA (US); Smijo Vincent, Hyderabad (IN); Pradeep Singh Rawat, Ghaziabad (IN)

(73) Assignee: BANK OF AMERICA CORPORATION, Charlotte, NC (US)

(21) Appl. No.: 18/520,942

(22) Filed: Nov. 28, 2023

(51) Int. Cl. G06F 8/61; G06F 8/35

(52) U.S. Cl. CPC G06F 8/61; G06F 8/35

(57) ABSTRACT

Systems, computer program products, and methods are described herein for improving computing performance by implementing an application package orchestrator in an electronic environment. The present disclosure is configured to identify an instruction(s) associated with a current application(s); apply the instruction(s) to an NLP engine; generate, by the NLP engine, a stepwise metadata packet, wherein the stepwise metadata packet comprises a standardized set of computer-readable instructions; apply the stepwise metadata packet to an application package orchestrator model; query, by the application package orchestrator model, a programming template database based on the stepwise metadata package, wherein the programming template database comprises pre-generated programming actions; determine, based on the query, whether the pre-generated programming actions resolve each of the standardized set of computer-readable instructions of the stepwise metadata packet; and generate an application package based on a combination of the pre-generated programming actions that resolve each of the standardized set of computer-readable instructions.

### TECHNOLOGICAL FIELD

Example embodiments of the present disclosure relate to improving computing performance by implementing an application package orchestrator in an electronic environment.

### BACKGROUND

When programs and applications are being created, especially manually by different approaches and different software engineers, the application packages themselves will differ based on each software engineer's preferences, experience, and/or the like. Such differences between application packages may thus cause differences in computer component efficiency as software packages may not use efficient and/or streamlined approaches to solve the problem(s) the application packages hope to solve. Additional problems arise where customizations to pre-existing applications and/or customizations in brand new applications need to occur and software engineers may vary in how they would carry out these customization instructions, which could in turn to lead to disagreements, long wait times to completion of the application package (e.g., such as long wait times due to differing opinions on how to resolve the customization instructions, and/or the like), overload on certain computing components as some software engineers may prefer to use some computing components over others, and/or the like. Thus, there exists a need for a system to efficiently and dynamically generate software application packages in a standardized and streamlined manner and without the need for manual intervention.

Applicant has identified a number of deficiencies and problems associated with improving computer performance by standardizing application packages even in customization scenarios, and streamlining the generation of application packages. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for improving computing performance by implementing an application package orchestrator in an electronic environment.

In one aspect, a system for improving computing performance by implementing an application package orchestrator in an electronic environment is provided. In some embodiments, the system may comprise: a memory device with computer-readable program code stored thereon; at least one processing device, wherein executing the computer-readable code is configured to cause the at least one processing device to perform the following operations: identify at least one instruction associated with at least one current application; apply the at least one instruction to an NLP engine; generate, by the NLP engine, a stepwise metadata packet, wherein the stepwise metadata packet comprises a standardized set of computer-readable instructions; apply the stepwise metadata packet to an application package orchestrator model; query, by the application package orchestrator model, a programming template database based on the stepwise metadata package, wherein the programming template database comprises at least one pre-generated programming action; determine, based on the query, whether the at least one pre-generated programming action resolve each of the standardized set of computer-readable instructions of the stepwise metadata packet; and generate an application package based on a combination of the at least one pre-generated programming action that resolve each of the standardized set of computer-readable instructions.

In some embodiments, the at least one instruction comprises a combination of two or more instructions.

In some embodiments, the stepwise metadata packet comprises a standardized arrangement of the set of computer-readable instructions.

In some embodiments, and in an instance where the at least one pre-generated programming action does not resolve each of the standardized set of computer-readable instructions, execute the computer-readable code configured to cause the at least one processing device to perform the following operations: apply the standardized set of computer-readable instructions that are not resolved by the at least one pre-generated programming action to the application package orchestrator model; generate, by the application package orchestrator model, at least one custom program action; validate the at least one custom program action and determine the at least one custom program action resolves the standardized set of computer-readable instructions; and generate, based on the validation and determination of the at least one custom program action, the application package based on at least the at least one custom program action. In some embodiments, the custom program action comprises a modification to at least one pre-generated programming action.

In some embodiments, the computer-readable code is configured to cause the at least one processing device to perform the following operation of storing the at least one custom program action in the programming template database.

In some embodiments, the application package orchestrator model categorizes the at least one current application as at least one of a simple category, medium category, or complex category.

In some embodiments, the application package orchestrator model is configured to automatically perform an upgrade, an install, or an uninstall of at least one of the at least one current application or the application package.

In some embodiments, executing the computer-readable code is configured to cause the at least one processing device to perform the following operations: validate the application package, wherein, in an instance where the application package is invalidated, rollback the application package, or wherein, in an instance where the application package is validated, automatically commit the application package and transmit the application package to at least one computing component.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for improving computing performance by implementing an application package orchestrator in an electronic environment, in accordance with an embodiment of the disclosure;

FIG. 2 illustrates an exemplary natural language processor (NLP) subsystem architecture, in accordance with an embodiment of the disclosure;

FIG. 3 illustrates an exemplary machine learning (ML) subsystem architecture, in accordance with an embodiment of the disclosure;

FIG. 4 illustrates a process flow for improving computing performance by implementing an application package orchestrator in an electronic environment, in accordance with an embodiment of the disclosure;

FIG. 5 illustrates a process flow for generating and/or storing the at least one custom program action, in accordance with an embodiment of the disclosure;

FIG. 6 illustrates a process flow for validating the application package, in accordance with an embodiment of the disclosure; and

FIG. 7 illustrates an exemplary flow diagram for improving computing performance by implementing an application package orchestrator in an electronic environment, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, devices, data, and the like, and/or the ability and opportunity to access and use the same. Some example implementations herein contemplate property held by a user, including property that is stored and/or maintained by a third-party entity, such as in a third-party entity's data centers. In some example implementations, a resource may be associated with one or more accounts (e.g., a user account) or may be property that is not associated with a specific account. For purposes of this disclosure, a resource is typically stored in a resource repository-a storage location where one or more resources are organized, stored and retrieved electronically using a computing device.

When programs and applications are being created, especially manually by different approaches and different software engineers, the application packages themselves will differ based on each software engineer's preferences, experience, and/or the like. Such differences between application packages may thus cause differences in computer component efficiency as software packages may not use efficient and/or streamlined approaches to solve the problem(s) the application packages hope to solve. Additional problems arise where customizations to pre-existing applications and/or customizations in brand new applications need to occur and software engineers may vary in how they would carry out these customization instructions, which could in turn to lead to disagreements, long wait times to completion of the application package (e.g., such as long wait times due to differing opinions on how to resolve the customization instructions, and/or the like), overload on certain computing components as some software engineers may prefer to use some computing components over others, and/or the like. Thus, there exists a need for a system to efficiently and dynamically generate software application packages in a standardized and streamlined manner and without the need for manual intervention.

This disclosure provides an application packaging system, whereby the application packaging system receives instructions in normal everyday language, converts the language to step-by-step metadata using an NLP engine, inputs the step-by-step metadata to an orchestrator module (which comprises a machine learning model) which generates an application package that can be easily validated, tested, and uploaded to a computing device. In some embodiments, the invention uses a repository of previously-used and verified templates to build out the application package. In this manner, the invention provides an automatic, dynamic, and efficient way to generate application packages from natural language, testing the application package, and uploading the tested application package without manual intervention. Additionally, the invention further provides a method for generating custom application packages by using a custom action repository—which in turn uses different pieces of previously used templates or generates brand new templates—to build out a custom application package, test the application package, and update the database of accepted templates/roll out the custom application package once verified. Lastly, and importantly, the invention also provides a mechanism for automatically running through the process of generating the upgraded application package, installing the upgraded application package, and uninstalling the previous application package. Such an invention, on its basis, will improve computing functionality, performance, and efficiency by allowing for standardization of application packages and by generating custom standardized application packages in an efficient, dynamic, standardized, and automatic manner.

Accordingly, the present disclosure provides for identifying at least one instruction (e.g., an instruction provided by a client of the system, an instruction provided by an employee associated with a client of the system, an instruction provided by a layperson, and/or the like) associated with at least one current application; applying the at least one instruction to an NLP engine; and generating, by the NLP engine, a stepwise metadata packet, wherein the stepwise metadata packet comprises a standardized set of computer-readable instructions (e.g., instructions that would be understood by a computing component such as an application package orchestrator model). Further, the disclosure provides for applying the stepwise metadata packet to an application package orchestrator model; querying, by the application package orchestrator model, a programming template database based on the stepwise metadata package, wherein the programming template database comprises at least one pre-generated programming action (e.g., pre-existing application packages, pre-existing lines of code, and/or the like); determining, based on the query, whether the at least one pre-generated programming action resolves each of the standardized set of computer-readable instructions of the stepwise metadata packet; and generating an application package based on a combination of the at least one pre-generated programming action that resolve each of the standardized set of computer-readable instructions.

What is more, the present disclosure provides a technical solution to a technical problem. As described herein, the technical problem includes improving computer performance by standardizing application packages even in customization scenarios, and streamlining the generation of application packages. The technical solution presented herein allows for the standardized, dynamic and efficient generation of application packages using machine learning and natural language processing. In particular, the disclosure is an improvement over existing solutions to the problems identified herein, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

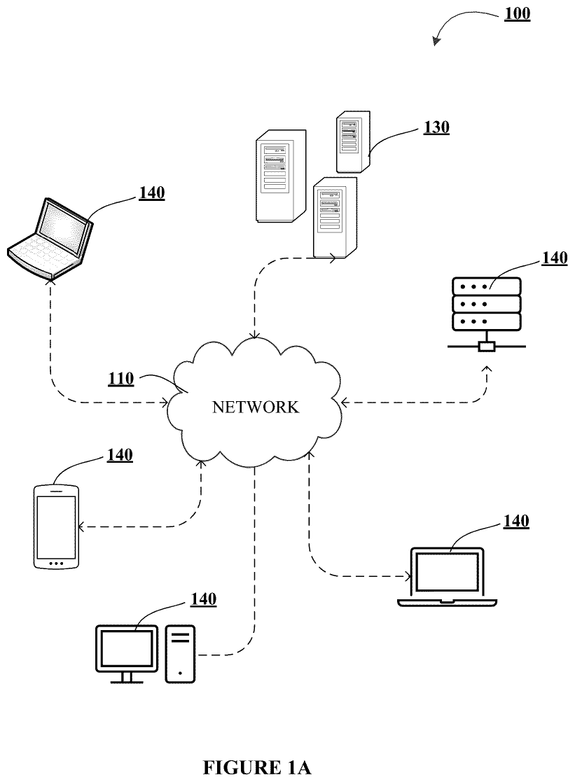

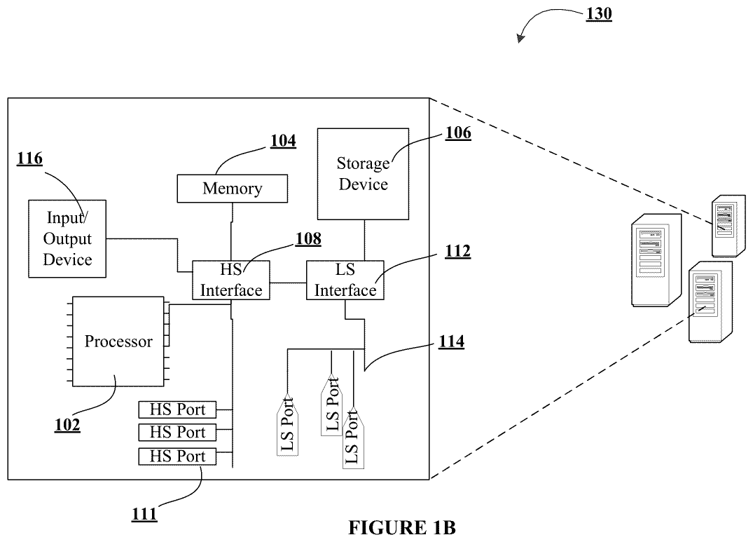

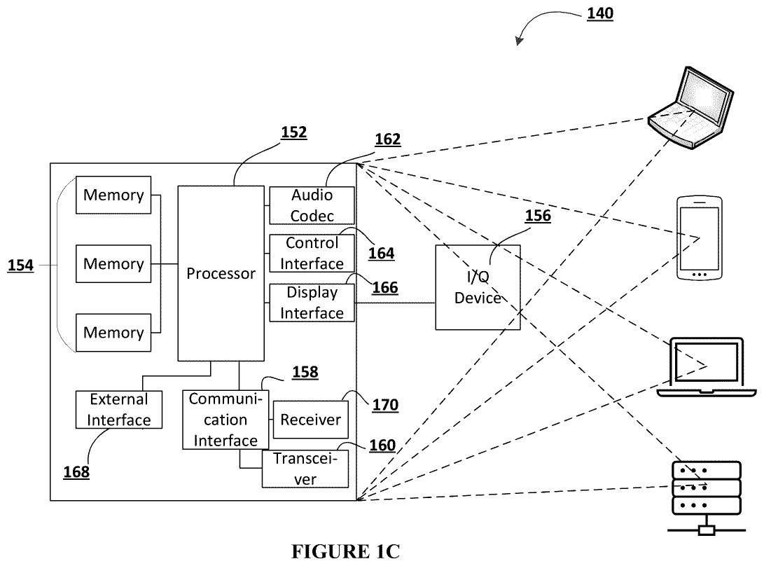

FIGS. 1A-1C illustrate technical components of an exemplary distributed computing environment for improving computing performance by implementing an application package orchestrator in an electronic environment 100, in accordance with an embodiment of the invention. As shown in FIG. 1A, the distributed computing environment 100 contemplated herein may include a system 130 (i.e., a system configured for improving computing performance by implementing an application package orchestrator in an electronic environment), an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low speed bus 114 (shown as “LS Port”) and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

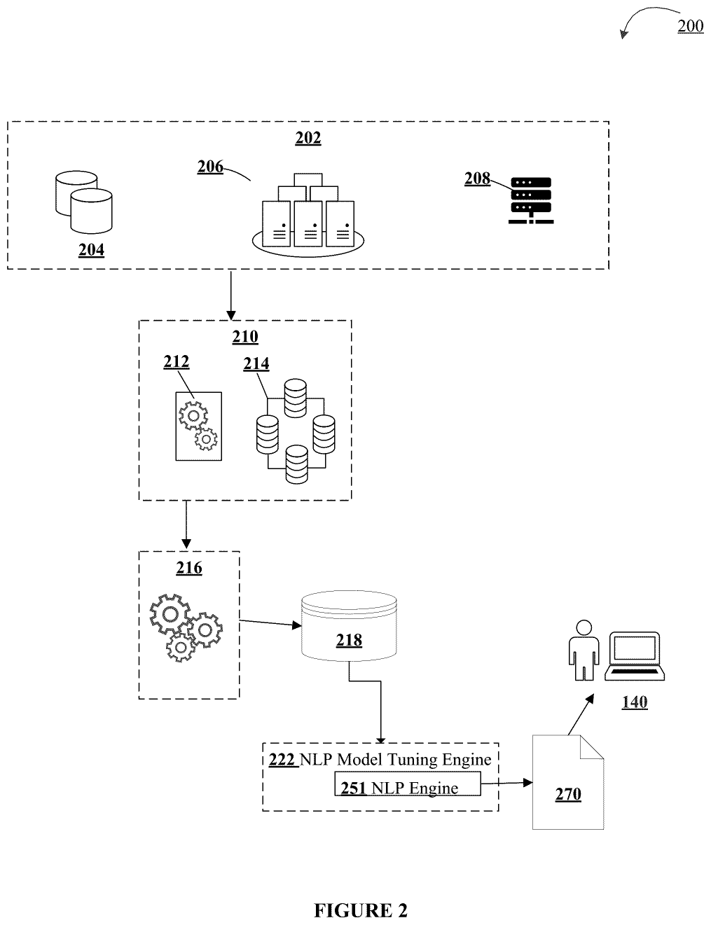

FIG. 2 illustrates an exemplary Natural Language Processing (NLP) subsystem architecture 200, in accordance with an embodiment of the disclosure. The NLP subsystem 200 may include a data acquisition engine 202, data ingestion engine 210, data pre-processing engine 216, NLP model tuning engine 222, inference engine 236, and NLP engine 251.

The data acquisition engine 202 may identify various internal and/or external data sources to generate, test, and/or integrate new features for training the NLP engine 251 (such as by gathering at least one unstructured datasets like that shown in as datasets 206). These internal and/or external data sources 204, 206, and 208 may be initial locations where the data originates or where physical information is first digitized (such as within a database, such as a database of change requests, modifications, and/or the like). The data acquisition engine 202 may identify the location of the data and describe connection characteristics for access and retrieval of data.

In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include databases associated with computer programming modifications by development teams and their associated change requests that precipitated the modifications, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. In some embodiments, and since the data may come from different places, it may need to be cleansed and transformed so that it can be analyzed together with data from other sources, such as by cleansing the data of non-important text such as periods (“.”) and/or the like. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In natural language processing, the quality of data and the useful information that can be derived therefrom directly affects the ability of the natural language processing engine 251. The data pre-processing engine 216 may implement advanced integration and processing steps needed to prepare the data for NLP execution. This may include modules to perform any upfront, data transformation to consolidate the data into alternate forms by changing the value, structure, or format of the data using generalization, weightage values, fuzzy the terms of the unstructured datasets, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. In some embodiments, the training data 218 may comprise pre-labeled modifications, natural language interpretations, and/or the like. Further, and in some embodiments, the training data 218 may be pre-labeled by users associated with the development team of the computer program(s) and/or by a user that input the change requests. Feature extraction and/or selection is a process of dimensionality reduction by which an initial set of data is reduced to more manageable groups for processing. In some embodiments, the training data 218 may require further enrichment. For example, in supervised learning, the training data is enriched using one or more meaningful and informative labels to provide context so the NLP engine 251 can learn from it. In contrast, unsupervised learning uses unlabeled data to find patterns in the data, such as inferences or clustering of data points, such as by being trained on non-labeled change requests and associated modifications.

An NLP engine tuning engine 222 may be used to train the NLP engine 251 using the training data 218 to make predictions or decisions without explicitly being programmed to do so. The NLP engine 251 represents what was learned by a selected machine learning algorithm 220 and represents the rules, numbers, and any other algorithm-specific data structures required for classification.

In some embodiments, the NLP engine 251 may include machine learning supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the NLP engine 251, the NLP tuning engine 222 may repeatedly execute cycles of experimentation, testing, and tuning to optimize the performance of the NLP engine 251 and refine the results in preparation for deployment of those results for consumption or decision making. To this end, the NLP tuning engine 222 may vary hyperparameters each iteration, run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained NLP engine 251 is one whose hyperparameters are tuned and accuracy maximized.

The trained NLP engine 251, similar to any other software application output, can be persisted to storage, file, memory, or application, or looped back into the processing component to be reprocessed. More often, the trained NLP engine 251 is deployed into an existing production environment to make accurate decisions on unstructured data based on live data (e.g., unstructured datasets and input data). For instance, such an unstructured dataset/a plurality of future unstructured datasets may be input to the training NLP engine 251 (which includes parsing the terms of the unstructured dataset(s), determining the meaning of each of the modifications and their purposes within the computer program, the meaning of the change requests, and/or the like. Further, and based on the structured dataset generated by the trained NLP engine 251, the computer language interpretation system may generate an interface component (e.g., a modification interpretation database, and/or the like).

It will be understood that the embodiment of the NLP subsystem 200 illustrated in FIG. 2 is exemplary and that other embodiments may vary. As another example, in some embodiments, the NLP subsystem 200 may include more, fewer, or different components.

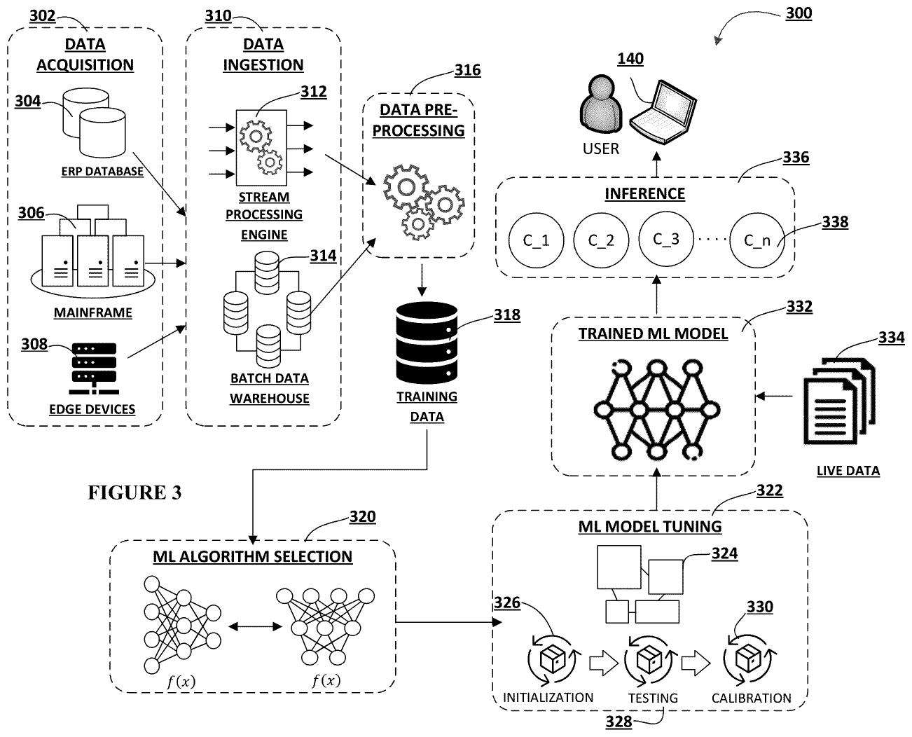

FIG. 3 illustrates an exemplary machine learning (ML) subsystem architecture 300, in accordance with an embodiment of the invention. The machine learning subsystem 300 may include a data acquisition engine 302, data ingestion engine %10, data pre-processing engine %16, ML model tuning engine %22, and inference engine %36.

The data acquisition engine %02 may identify various internal and/or external data sources to generate, test, and/or integrate new features for training the machine learning model %24. These internal and/or external data sources %04, %06, and %08 may be initial locations where the data originates or where physical information is first digitized. The data acquisition engine %02 may identify the location of the data and describe connection characteristics for access and retrieval of data. In some embodiments, data is transported from each data source %04, %06, or %08 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 304, 306, and 308 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 302 from these data sources 304, 306, and 308 may then be transported to the data ingestion engine 310 for further processing.

Depending on the nature of the data imported from the data acquisition engine 302, the data ingestion engine 310 may move the data to a destination for storage or further analysis. Typically, the data imported from the data acquisition engine 302 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 302, the data may be ingested in real-time, using the stream processing engine 312, in batches using the batch data warehouse 314, or a combination of both. The stream processing engine 312 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 314 collects and transfers data in batches according to scheduled intervals, trigger events, or any other logical ordering.

In machine learning, the quality of data and the useful information that can be derived therefrom directly affects the ability of the machine learning model 324 to learn. The data pre-processing engine 316 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 316 may implement feature extraction and/or selection techniques to generate training data 318. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 318 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 322 may be used to train a machine learning model 324 using the training data 318 to make predictions or decisions without explicitly being programmed to do so. The machine learning model 324 represents what was learned by the selected machine learning algorithm 320 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 322 may repeatedly execute cycles of experimentation 326, testing 328, and tuning 330 to optimize the performance of the machine learning algorithm 320 and refine the results in preparation for deployment of those results for consumption or decision making. To this end, the ML model tuning engine 322 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 318. A fully trained machine learning model 332 is one whose hyperparameters are tuned and model accuracy maximized.

The trained machine learning model 332, similar to any other software application output, can be persisted to storage, file, memory, or application, or looped back into the processing component to be reprocessed. More often, the trained machine learning model 332 is deployed into an existing production environment to make practical business decisions based on live data 334. To this end, the machine learning subsystem 300 uses the inference engine 336 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 338) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 338) live data 334 based on how similar they are to one another to solve exploratory challenges where little is known about the data, provide a description or label (e.g., C_1, C_2 . . . C_n 338) to live data 334, such as in classification, and/or the like. These categorized outputs, groups (clusters), or labels are then presented to the user input system 130. In still other cases, machine learning models that perform regression techniques may use live data 334 to predict or forecast continuous outcomes.

It will be understood that the embodiment of the machine learning subsystem 300 illustrated in FIG. 3 is exemplary and that other embodiments may vary. As another example, in some embodiments, the machine learning subsystem 300 may include more, fewer, or different components.

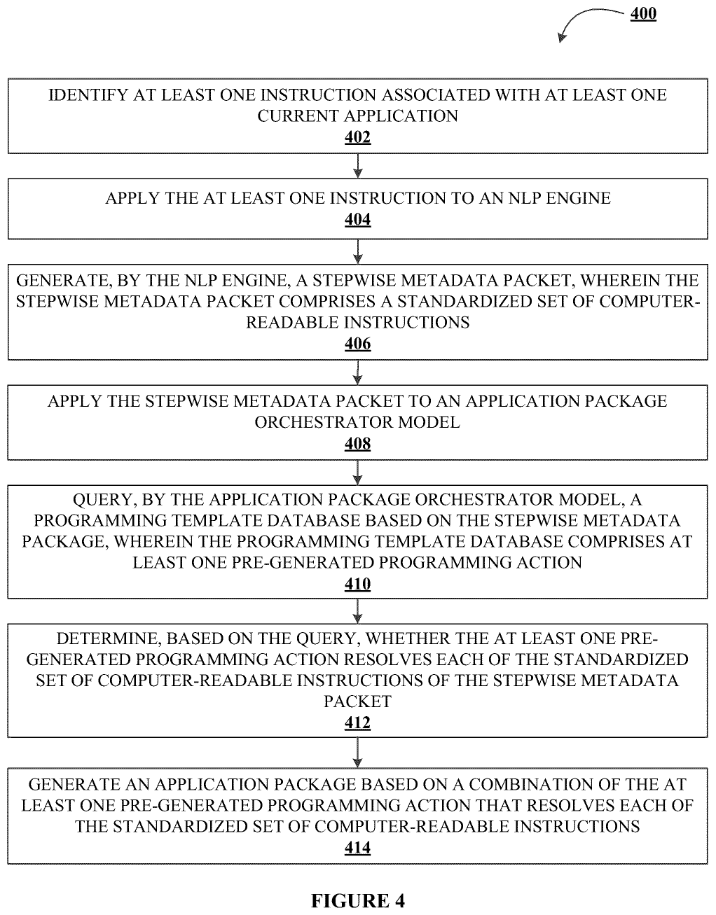

FIG. 4 illustrates a process flow 400 for improving computing performance by implementing an application package orchestrator in an electronic environment, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 500. In some embodiments, an NLP engine (e.g., such as the NLP subsystem shown in FIG. 2) and/or a machine learning (ML) model (e.g., such as the ML subsystem shown in FIG. 3) may perform some or all of the steps described in process flow 400.

As shown in block 402, the process flow 400 may include the step of identifying at least one instruction associated with at least one current application. As used herein, the at least one instruction refers to a command, a request, a directive, and/or the like written in human- readable text (e.g., layman's terms and layman's format/syntax) which are associated with at least one application. For example, the at least one instruction may be used as a command, directive, request, and/or the like, to generate a new application package, install an application package (e.g., install a new application package, install an upgrade to a pre-existing application package, and/or the like), upgrade an already existing application package, uninstall an already existing application package, and/or the like, in a human-readable text, format, syntax, and/or the like (e.g., full sentences and/or received as a part of other instructions for the same or other applications). Thus, and in some embodiments, the at least one instructions may comprise a plurality of instructions (e.g., received as a paragraph or plurality of sentences in a paragraph form, whereby each sentence may comprise its own instruction and/or only a portion of the sentences may comprise their own instructions), such as a plurality of two or more instructions.

As used herein, the term “current application package” refers to an application that already exists (e.g., such as in a computing component, in a software environment, and/or the like) and/or an application that does not already exist, but may exist after the at least one instruction(s) are used to generate the application.

Additionally, and in some embodiments, the at least one instruction may be identified based on receiving—from a user device and via a network (such as the network 110 shown in FIG. 1A)—the at least one instruction by the system. In some embodiments, such an instruction (and/or instructions) may be received from a user device associated with a client of the system (e.g., such as an employee associated with a client of the system that may wish to have an application that performs a specific function, but does not know how to program the application). In some embodiments, and upon receiving the at least one instruction, the at least one instruction (and/or packet of plurality of instructions) may be sorted and queued based on the timestamp the instruction(s) were received by the system, and then upon completion of the previous instruction(s) of the queue, the system may move on to the current instruction(s) in the queue for processing and completion.

As shown in block 404, the process flow 400 may include the step of applying the at least one instruction to an NLP engine. For example, the application of the at least one instruction to the NLP engine means to apply it so the NLP engine can process the at least one instruction. In some embodiments, the application of the at least one instruction may comprise applying all the instructions of the at least one instruction at one time such that they are processed together (e.g., where there are a plurality of instructions in the at least one instruction for a current application). In some other embodiments, the application of the at least one instruction may comprise applying the instructions of the at least one instruction in stages and/or not at one time (e.g., but at similar times such that each instruction of the at least one instruction is processed by the NLP engine together and sequentially).

As shown in block 406, the process flow 400 may include the step of generating—by the NLP engine—a stepwise metadata packet, wherein the stepwise metadata packet comprises a standardized set of computer-readable instructions. For example, the stepwise metadata packet may comprise a standardized set of computer-readable instructions, whereby the standardized set of computer-readable instructions comprises the previously identified at least one instruction(s) converted into a computer-readable format, syntax, and text (e.g., into programming language which is formatted in a correct manner such that an application package orchestrator model can process and resolve the instruction(s) in an efficient and accurate manner).

Further, and in some embodiments, the stepwise metadata packet may comprise a standardized arrangement of the computer-readable instructions, whereby the process to generate the standardized arrangement comprises an automatic restructuring and/or re-organization of the instruction(s) received and/or identified into a standardized structure for the standard set computer-readable instructions. In some embodiments, the automatic restructuring may comprise a determination of the order of the computer-readable instruction(s) based on the instruction(s) identified/received and based on which tasks need to be completed in a particular order to generate the application package. For instance, and in some embodiments, the order may be determined based on a hierarchy of tasks (such as a hierarchy of tasks indicating that the current application should be executed first, any required written permissions that need to be executed, whether the current application need to be “killed” or stopped before an upgrade can occur, and/or the like) which should be completed in a particularized order. In some embodiments, the particularized order may be based on which pre-requisite tasks must always be completed before an application package can be rolled out or committed to a computer component, may be based on pre-identified orders received from a manager of the system, and/or the like.

As shown in block 408, the process flow 400 may include the step of applying the stepwise metadata packet to an application package orchestrator model. As used herein, the application of the stepwise metadata packet to the application package orchestrator model—which is trained and configured for generating an application package based on the stepwise metadata packet and its associated computer-readable instructions—comprises a processing of the stepwise metadata packet by the application package orchestrator model.

In some embodiments, the application package orchestrator model categorizes the at least one current application as at least one of a simple category, medium category, or complex category. For example, and in some embodiments, once the instruction(s) are received and/or identified, the system may determine which current application the instruction(s) are intended to generate an application package for, and based on the current application's complexity, the application package orchestrator model may categorize the at least one current application as a simple category (e.g., not complex), medium category (slightly complex), or complex category (e.g., very complex). In some embodiments, the complexity determination of the current application may be based on a variety of factors, such as but not limited to the number of computer components the current application is stored in, the workflows of the current application and whether they are linear (e.g., non-complex) or non-linear (e.g., complex), the number of databases and/or datacenters that are queried by the application regularly, and/or the like. Thus, and based on these categorizations, the application package orchestrator can determine the pre-requisite tasks and/or the hierarchy of tasks for the stepwise metadata packet.

In some embodiments, the application package orchestrator model is configured to automatically perform an upgrade, an install, or an uninstall of at least one of the at least one current application or the application package. For example, and in some embodiments, the system—via the application package orchestrator model—may determine whether the current application needs to be uninstalled to commit or roll out (e.g., install) the application package generated and/or or to upgrade the current application with the application package generated. Thus, and in some embodiments, the application package orchestrator model can automatically and dynamically determine whether a current application needs to be uninstalled, installed, and/or upgraded, and whether the application package generated at the current time must also be installed to upgrade the current application and/or replace the current application.

As shown in block 410, the process flow 400 may include the step of querying—by the application package orchestrator model—a programming template database based on the stepwise metadata package, wherein the programming template database comprises at least one pre-generated programming action. As used herein, the term “query” and/or “querying” refers to searching and/or submitting a request for a computer storage component (e.g., a programming template database) to search itself in order to find the computer component identified in the query (e.g., the pre-generated programming action that will resolve the computer-readable instruction(s) of the stepwise metadata packet). By way of example, the programming template database may comprise a plurality of pre-generated programming components (such as lines of code, a plurality of lines of code, databases, tables, indexes, files, and/or the like) which may be used by the application package orchestrator model to build an application package (e.g., such as by combining the pre-generated programming components, filling in the necessary data from the stepwise metadata packet such as any inputs necessary for the instructions to be resolved, and/or the like) that resolves the instruction(s) received and/or identified from block 402.

In some embodiments, the application package orchestrator model may be pre-trained based on previous application packages that have been generated (e.g., such as by manual generation, manual intervention, by previous application packages generated by the application package orchestrator package, and/or the like). Additionally, and in some embodiments, the application package orchestrator model may be trained by feedback from user devices associated with a client device of the system (e.g., from employee(s) of the client of the system that are using the application package(s) after they have been rolled out). Such feedback may be received via user inputs from a user device and transmitted to the system via a network, such as network 110 of FIG. 1A.

As shown in block 412, the process flow 400 may include the step of determining—based on the query—whether the at least one pre-generated programming action resolves each of the standardized set of computer-readable instructions of the stepwise metadata packet. For example, the determination of whether the pre-generated programming action resolves the standardized set of computer-readable instructions comprises a determination that each of the computer-readable instructions (and their requests) have been solved or met by at least one pre-generated programming action.

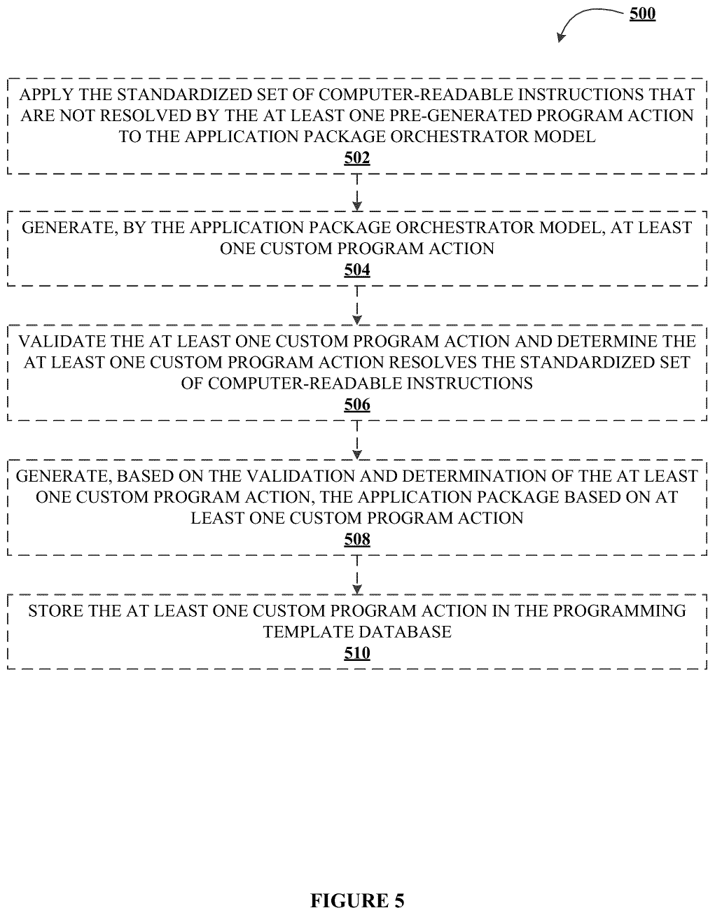

Thus, each of the computer-readable instructions must have been resolved, individually, and as a combination in order for the application package to be generated using only the pre-generated programming action(s). However, and in the embodiments where only a portion or none of the computer-readable instructions are resolved by the pre-generated programming actions, the system—via the application package orchestrator model—may generate its own custom program actions automatically and dynamically. Such an embodiment is described in further detail below with respect to FIG. 5.

As shown in block 414, the process flow 400 may include the step of generating an application package based on a combination of the at least one pre-generated programming action that resolves each of the standardized set of computer-readable instructions. As used herein, the term “application package” refers to a specialized program and/or a set of specialized programs (or files) that are designed and configured to carrying out a particular task, such as a particular task identified in the instructions received and/or identified at block 402. Thus, the application package(s) may be transmitted directly to computing components and/or computing devices, installed in the computing component and/or computing devices, and run/executed.

FIG. 5 illustrates a process flow 500 for generating and/or storing the at least one custom program action, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500. In some embodiments, an NLP engine (e.g., such as the NLP subsystem shown in FIG. 2) and/or a machine learning (ML) model (e.g., such as the ML subsystem shown in FIG. 3) may perform some or all of the steps described in process flow 500.

In some embodiments, and as shown in block 502, the process flow 500 may include the step of applying the standardized set of computer-readable instructions that are not resolved by the at least one pre-generated program action to the application package orchestrator model. For example, and in some embodiments, the application package orchestrator model may determine that custom program actions will be required in order to solve and/or meet each of the computer-readable instructions of the standardized set of computer-readable instructions (e.g., where the pre-generated program actions do not comprise a method or program to resolve all the computer-readable instructions), whereby the custom program action will be generated and/or created by the application package orchestrator model automatically, dynamically, and efficiently.

In some embodiments, and as shown in block 504, the process flow 500 may include the step of generating—by the application package orchestrator model—at least one custom program action. For example, in some embodiments, the application package orchestrator model may generate a custom program action that will resolve one or more of the computer-readable instructions that were not already resolved by the pre-generated program actions of the programming template database. Such a custom program action may comprise—in some embodiments—a modification to a pre-generated program action (e.g., such as a slight modification, a major or more in-depth modification(s), and/or the like) to generate a custom program action that meets or solves the at least one computer-readable instructions. Such a modification may be based on the pre-trained application package orchestrator model, which has been trained based on previous instances of other custom program actions (e.g., such as previous manually generated custom program actions, custom program actions that have been generated by the application package orchestrator model and rolled out/installed, custom program actions that received positive feedback, and/or the like). Similarly, the pre-trained application package orchestrator model may be trained based on the task underlying the computer-readable instructions and whether another pre-generated program action has a similar task that it seeks to solve. Thus, and in such embodiments, the application package orchestrator model may be trained to slightly modify the similar pre-generated program action to solve the task of the computer-readable instruction.

In some embodiments, and as shown in block 506, the process flow 500 may include the step of validating the at least one custom program action and determining the at least one custom program action resolves the standardized set of computer-readable instructions. For example, and in some embodiments, the application package orchestrator model may validate the at custom program action(s) it generated to resolve the computer-readable instruction(s) based on comparing the output of the custom program action (e.g., upon applying an example input) to an expected output and determining whether the output of the custom program action matches the expected output. In the instance where the output of the custom program action does not match the expected output, the custom program action may be determined to be invalid. In the instance where the output of the custom program action does match the expected output, the custom program action may be determined to be valid. Similarly, and in some embodiments, the application package orchestrator model may determine that the custom action program will determine that the custom program action resolves the associated computer-readable instructions, such that each of the computer-readable instructions are resolved individually and as a combination (e.g., each requested task has been addressed and completed, the expected outputs have been verified, the hierarchy of tasks is correct in its solutions, and/or the like).

In some embodiments, and as shown in block 508, the process flow 500 may include the step of generating—based on the validation and determination of the at least one custom program action—the application package based on the at least one custom program action. Thus, and based on the validation and determination that the computer-readable instructions have all been resolved, the application package orchestrator model may generate the application package with each of the program actions used to resolve each of the computer- readable instructions (e.g., this may comprise a combination of pre-generated program actions and custom program actions, a combination of only pre-generated program actions, and/or a combination of only custom program actions).

In some embodiments, and as shown in block 510, the process flow 500 may include the step of storing the at least one custom program action in the programming template database. In some embodiments, the system may additionally and/or alternatively store the custom program actions that have been validated in the programming template database for future use. Thus, and by way of example, the application package orchestrator model may access the programming template database and may use previously generated custom program actions as pre-generated program actions for future application packages. Such storage of custom program actions in the programming template database leads to efficient and streamlined generation of future application packages.

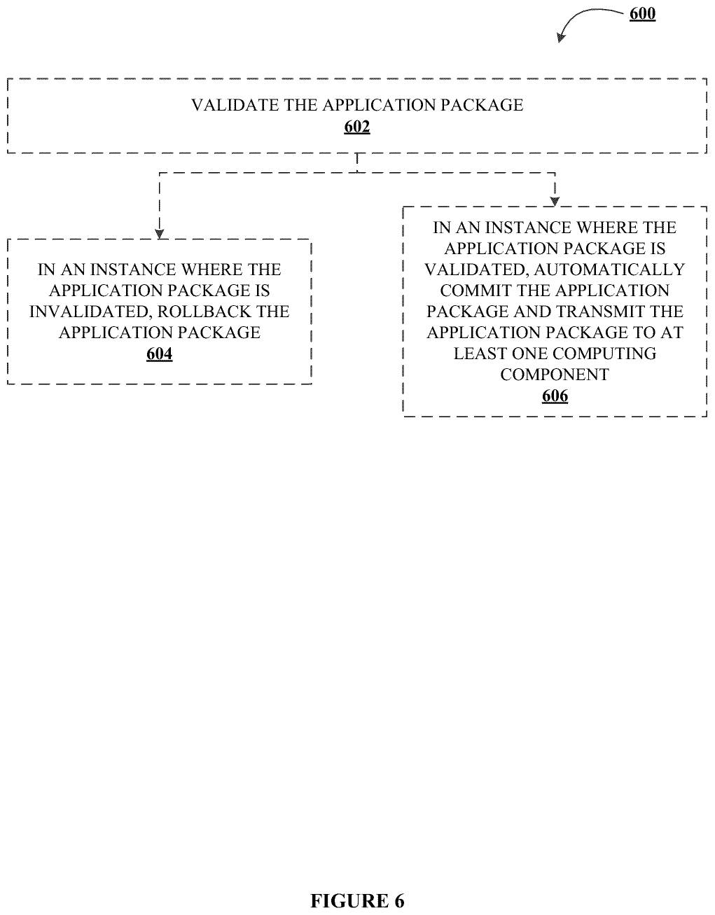

FIG. 6 illustrates a process flow 600 for validating the application package, in accordance with an embodiment of the disclosure. In some embodiments, a system (e.g., similar to one or more of the systems described herein with respect to FIGS. 1A-1C) may perform one or more of the steps of process flow 600. For example, a system (e.g., the system 130 described herein with respect to FIG. 1A-1C) may perform the steps of process 600. In some embodiments, an NLP engine (e.g., such as the NLP subsystem shown in FIG. 2) and/or a machine learning (ML) model (e.g., such as the ML subsystem shown in FIG. 3) may perform some or all of the steps described in process flow 600.

In some embodiments, and as shown in block 602, the process flow 600 may include the step of validating the application package. For instance, and similar to the disclosure provided above, the system may validate the application package in a similar manner to the validation of the custom program actions (e.g., by applying an exemplary input and comparing the output of the application package against an expected output and validating the application package where the output matches the expected output). Additionally, and/or alternatively, the system may validate the application package by generating a plurality of example inputs and/or interactions into the application package and analyzing the outputs and/or application output interactions (e.g., the graphical user interface components that are generated which may be read by a user using a user device that is configured by the graphical user interface components to give information regarding the inputs and/or the outputs of the application package) to determine whether the application package meets the needs of the instructions and meets those needs in an accurate, efficient, easily-viewable manner, and with as little computing component consumption as possible (e.g., which may be determined by interactions and query counts to outside data centers, outside databases, indexes, and/or the like).

In some embodiments, and as shown in block 604, the process flow 600 may include the step of rolling back (i.e., rollback) the application package in the instance where the application package is invalidated. Thus, and once the application package has been determined as invalid, the system may rollback and/or halt the application package from being installed on any computing devices. Further, and in some embodiments, the application package orchestrator model may take the data of the invalidated application package, be trained by the data, and re-execute the processes described herein to generate a new or updated application package (which may then be determined as valid or invalid).

In some embodiments, and as shown in block 606, the process flow 600 may include the step of automatically committing the application package and transmitting the application package to at least one computing component in the instance where the application package is validated. Thus, and once the application package has been determined as valid, the application package may be automatically committed and installed on computing device(s) and/or component(s) (e.g., those computing device(s) or component(s) that may have already had the current application of block 302 installed previously) and will be ready for use on those computing device(s) and/or component(s).

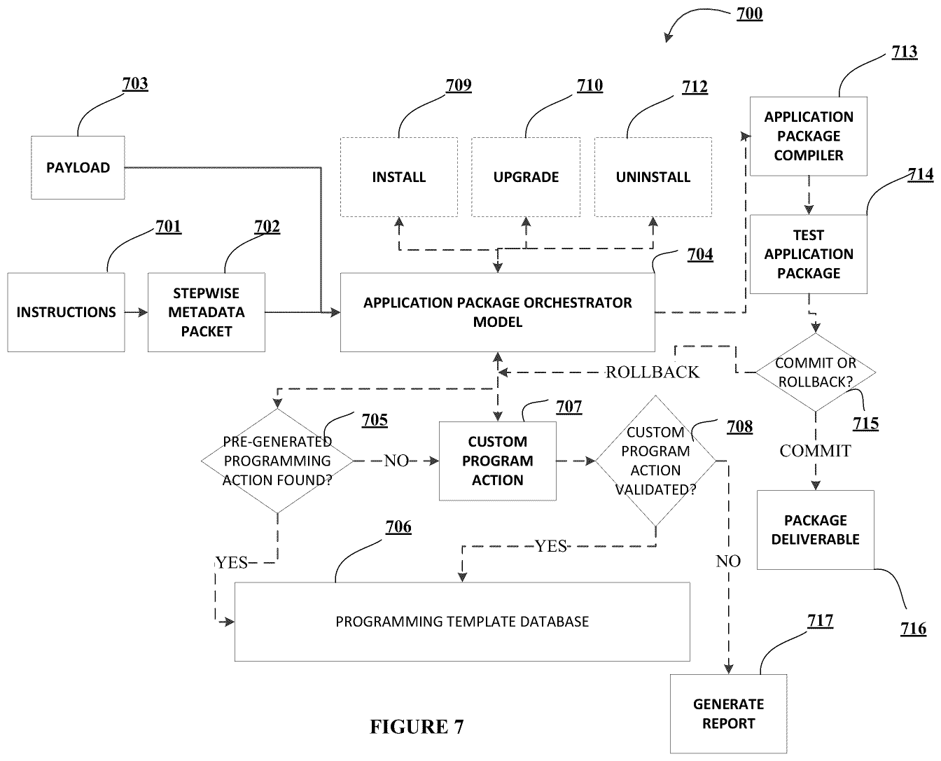

FIG. 7 illustrates an exemplary flow diagram 700 for improving computing performance by implementing an application package orchestrator in an electronic environment, in accordance with an embodiment of the disclosure. In some embodiments, a system (e.g., similar to one or more of the systems described herein with respect to FIGS. 1A-1C) may perform one or more of the steps of flow diagram 700. For example, a system (e.g., the system 130 described herein with respect to FIG. 1A-1C) may perform the steps of flow diagram 700. In some embodiments, an NLP engine (e.g., such as the NLP subsystem shown in FIG. 2) and/or a machine learning (ML) model (e.g., such as the ML subsystem shown in FIG. 3) may perform some or all of the steps described in flow diagram 700.

For instance, and as shown in exemplary flow diagram 700, the system may receive the instructions 701 (e.g., like the instructions described above with respect to block 402), generate—via an NLP engine—the stepwise metadata packet 702. By way of non-limiting example, the instructions 701 received and/or identified may comprise the paragraph statement:

Select a full installation. We need write permissions to the directory <C:\Program Files\Ruby> [version]. Also, this application will not install if the process Ruby.exe is already running. We would like to upgrade previous version.

The stepwise metadata packet 702 may read based on these instructions 701:
1. Execute program Ruby.exe-Full
2. Write Permissions on C:\Program Files\Ruby 2.6.1
3. Kill process Ruby.exe
4. Apply upgrade for product code identifier

Thus, and based on this data, a payload 703 (e.g., the application Ruby.exe which is the current application) will be identified and input to the application package orchestrator model 704 along with the computer-readable instructions of the stepwise metadata packet 702. Upon receiving the stepwise metadata packet 702 and the payload 703, the application package orchestrator model 704 will determine whether any of the pre-generated programming action(s) found 705 (e.g., based on the programming template database 706) can be used for the computer-readable instructions of the stepwise metadata packet 702. However, and in the instance where not all of the computer-readable instructions can be resolved by the pre-generated program action(s), the application package orchestrator model 704 will generate a custom program action 707 (e.g., such as by modifying at least one pre-generated program action from the programming template database.

Additionally, and upon generating the custom program action(s), the application package orchestrator model 704 will validate the custom program action(s) 708 to determine whether to use the custom program action(s) in the application package. In the instance where the custom program action(s) are invalidated, the application package orchestrator model 704 may generate a report regarding the custom program action(s) that were invalidated and transmit the report to a client of the system, to a manager of the system, and/or the like to indicate that the application package orchestrator model 704 is performing incorrectly or non-optimally. Such a report may comprise an interface component which is used to a configure a GUI of a user device (such as a user device associated with the client of the system and/or the manager of the system) to generate an alert that the system and its application package orchestrator model 704 is not operating optimally/is operating incorrectly.

Additionally, and/or alternatively, once the application package component(s) have been generated and/or selected, the application package orchestrator model 704 may transmit the components to an application package compiler 713 to generate the application package. Once the application package has been generated, the application package may be transmitted to a component within the system configured for testing the application package 714, and upon determining whether the application package is valid and performs the way it is intended, the system may commit (e.g., the application packages is valid and performs correctly and/or efficiently), the system may transmit the application package as a deliverable 716 to computing component(s) and/or device(s). In the instance where the application is determined as invalid and does not perform correctly, the system may rollback the application package and transmit the data of the failed application package back to the application package orchestrator model 704.

Additionally, and as shown in flow diagram 700, the application package orchestrator model 704 may be configured to perform installations 709, uninstallations 712, and/or upgrades 710 to current applications and/or the application packages as needed.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for improving computing performance by implementing an application package orchestrator in an electronic environment, the system comprising:
a memory device with computer-readable program code stored thereon;
at least one processing device, wherein executing the computer-readable code is configured to cause the at least one processing device to perform the following operations:
identify at least one instruction associated with at least one current application;
apply the at least one instruction to an NLP engine;
generate, by the NLP engine, a stepwise metadata packet, wherein the stepwise metadata packet comprises a standardized set of computer-readable instructions;
apply the stepwise metadata packet to an application package orchestrator model;
query, by the application package orchestrator model, a programming template database based on the stepwise metadata package, wherein the programming template database comprises at least one pre-generated programming action;
determine, based on the query, whether the at least one pre-generated programming action resolve each of the standardized set of computer-readable instructions of the stepwise metadata packet; and
generate an application package based on a combination of the at least one pre-generated programming action that resolve each of the standardized set of computer-readable instructions.

2. The system of claim 1, wherein the at least one instruction comprises a combination of two or more instructions.

3. The system of claim 1, wherein the stepwise metadata packet comprises a standardized arrangement of the set of computer-readable instructions.

4. The system of claim 1, wherein, in an instance where the at least one pre-generated programming action does not resolve each of the standardized set of computer-readable instructions, execute the computer-readable code configured to cause the at least one processing device to perform the following operations:
apply the standardized set of computer-readable instructions that are not resolved by the at least one pre-generated programming action to the application package orchestrator model;
generate, by the application package orchestrator model, at least one custom program action;
validate the at least one custom program action and determine the at least one custom program action resolves the standardized set of computer-readable instructions; and
generate, based on the validation and determination of the at least one custom program action, the application package based on at least the at least one custom program action.

5. The system of claim 5, wherein the custom program action comprises a modification to at least one pre-generated programming action.

6. The system of claim 1, wherein executing the computer-readable code is configured to cause the at least one processing device to perform the following operation
store the at least one custom program action in the programming template database.

7. The system of claim 1, wherein the application package orchestrator model categorizes the at least one current application as at least one of a simple category, medium category, or complex category.

8. The system of claim 1, wherein the application package orchestrator model is configured to automatically perform an upgrade, an install, or an uninstall of at least one of the at least one current application or the application package.

9. The system of claim 1, wherein executing the computer-readable code is configured to cause the at least one processing device to perform the following operations:
validate the application package,
wherein, in an instance where the application package is invalidated, rollback the application package, or
wherein, in an instance where the application package is validated, automatically commit the application package and transmit the application package to at least one computing component.

10. A computer program product for improving computing performance by implementing an application package orchestrator in an electronic environment, wherein the computer program product comprises at least one non-transitory computer-readable medium having computer-readable program code portions embodied therein, the computer-readable program code portions which when executed by a processing device are configured to cause the processor to perform the following operations:
identify at least one instruction associated with at least one current application;
apply the at least one instruction to an NLP engine;
generate, by the NLP engine, a stepwise metadata packet, wherein the stepwise metadata packet comprises a standardized set of computer-readable instructions;
apply the stepwise metadata packet to an application package orchestrator model;
query, by the application package orchestrator model, a programming template database based on the stepwise metadata package, wherein the programming template database comprises at least one pre-generated programming action;
determine, based on the query, whether the at least one pre-generated programming action resolve each of the standardized set of computer-readable instructions of the stepwise metadata packet; and
generate an application package based on a combination of the at least one pre- generated programming action that resolve each of the standardized set of computer- readable instructions.

11. The computer program product of claim 10, wherein the at least one instruction comprises a combination of two or more instructions.

12. The computer program product of claim 10, wherein the stepwise metadata packet comprises a standardized arrangement of the set of computer-readable instructions.

13. The computer program product of claim 10, wherein, in an instance where the at least one pre-generated programming action does not resolve each of the standardized set of computer-readable instructions,
apply the standardized set of computer-readable instructions that are not resolved by the at least one pre-generated programming action to the application package orchestrator model;
generate, by the application package orchestrator model, at least one custom program action;
validate the at least one custom program action and determine the at least one custom program action resolves the standardized set of computer-readable instructions; and
generate, based on the validation and determination of the at least one custom program, the application package based on at least the at least one custom program action.

14. The computer program product of claim 10, wherein the computer-readable program code portions which when executed by a processing device are configured to cause the processor to perform the following operation
store the at least one custom program action in the programming template database.

15. The computer program product of claim 10, wherein the application package orchestrator model is configured to automatically perform an upgrade, an install, or an uninstall of at least one of the at least one current application or the application package.

16. A computer implemented method for improving computing performance by implementing an application package orchestrator in an electronic environment, the computer implemented method comprising:
identifying at least one instruction associated with at least one current application;
applying the at least one instruction to an NLP engine;
generating, by the NLP engine, a stepwise metadata packet, wherein the stepwise metadata packet comprises a standardized set of computer-readable instructions;
applying the stepwise metadata packet to an application package orchestrator model;
querying, by the application package orchestrator model, a programming template database based on the stepwise metadata package, wherein the programming template database comprises at least one pre-generated programming action;
determining, based on the query, whether the at least one pre-generated programming action resolve each of the standardized set of computer-readable instructions of the stepwise metadata packet; and
generating an application package based on a combination of the at least one pre-generated programming action that resolve each of the standardized set of computer-readable instructions.

17. The computer implemented method of claim 16, wherein the at least one instruction comprises a combination of two or more instructions.

18. The computer implemented method of claim 16, wherein the stepwise metadata packet comprises a standardized arrangement of the set of computer-readable instructions.

19. The computer implemented method of claim 16, wherein, in an instance where the at least one pre-generated programming action do not resolve each of the standardized set of computer-readable instructions, wherein the computer implemented method further comprises:
applying the standardized set of computer-readable instructions that are not resolved by the at least one pre-generated programming action to the application package orchestrator model;
generating, by the application package orchestrator model, at least one custom program action;
validating the at least one custom program action and determine the at least one custom program action resolves the standardized set of computer-readable instructions; and
generating, based on the validation and determination of the at least one custom program, the application package based on at least the at least one custom program action.

20. The computer implemented method of claim 16, the computer implemented method further comprising:
storing the at least one custom program action in the programming template database.
